(19) United States
(12) Patent Application Publication
(10) Pub. No.: US 2026/0161500 A1
(43) Pub. Date: Jun. 11, 2026

(54) APPARATUSES AND METHODS FOR DISTRIBUTING AUXILIARY DATA

(71) Applicant: Micron Technology, Inc., Boise, ID (US)

(72) Inventor: Daniele Balluchi, Cernusco Sul Naviglio (IT)

(21) Appl. No.: 19/401,759

(22) Filed: Nov. 26, 2025

Related U.S. Application Data
(60) Provisional application No. 63/729,748, filed on Dec. 9, 2024.

(51) Int. Cl. G06F 11/10

(52) U.S. Cl. CPC G06F 11/1004

(57) ABSTRACT

Apparatuses and methods for distributing auxiliary data are described. By utilizing previously reserved spaces, the present disclosure allow for the efficient placement of both user and extra data, ensuring data quality is maintained even with the reduced number of channels, thereby addressing the limitations of smaller memory systems.

### PRIORITY INFORMATION

This Application claims the benefits of U.S. Provisional Application Number 63/729,748, filed on December 9, 2024, the contents of which are incorporated herein by reference.

### TECHNICAL FIELD

The present disclosure relates generally to semiconductor memory and methods, and more particularly, to apparatuses, systems, and methods related to distributing auxiliary data.

### Background

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, ferroelectric random access memory (FeRAM), and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

FIG. 1 is a functional block diagram of a computing system including a memory controller in accordance with a number of embodiments of the present disclosure.

FIG. 2A is a functional block diagram of a memory controller for auxiliary data protection in accordance with a number of embodiments of the present disclosure.

FIG. 2B is another functional block diagram of a memory controller for auxiliary data protection in accordance with a number of embodiments of the present disclosure.

FIG. 3A schematically illustrates an example of data placement on memory dice in accordance with a number of embodiments of the present disclosure.

FIG. 3B is a detailed illustration of a portion of data placement shown in FIG. 3A in accordance with a number of embodiments of the present disclosure.

FIG. 4A schematically illustrates another example of data placement on memory dice in accordance with a number of embodiments of the present disclosure.

FIG. 4B is a detailed illustration of a portion of data placement shown in FIG. 4A in accordance with a number of embodiments of the present disclosure.

FIG. 5A schematically illustrates another example of data placement on memory dice in accordance with a number of embodiments of the present disclosure.

FIG. 5B is a detailed illustration of a portion of data placement shown in FIG. 5A in accordance with a number of embodiments of the present disclosure.

FIG. 6 illustrates an example of how RAID parity data can be spread among channels of the memory system in accordance with a number of embodiments of the present disclosure.

FIG. 7 illustrates another example of how RAID parity data can be spread among channels of the memory system in accordance with a number of embodiments of the present disclosure.

FIG. 8 illustrates another example of how RAID parity data can be spread among channels of the memory system in accordance with a number of embodiments of the present disclosure.

FIG. 9 is a flow diagram corresponding to a method for distributing auxiliary data in accordance with a number of embodiments of the present disclosure.

### DETAILED DESCRIPTION

Systems, apparatuses, and methods related to distributing auxiliary data are described. Data received from hosts (referred to as “host data” or “user data”) can be stored in memory media (e.g., memory banks, dice, etc.). Further, extra data (e.g., not received from the host) is generated based on the user data to ensure the quality of the user data. For example, the extra data can provide data protection, integrity, and consistency of the user data. As an example, the extra data can include parity bits used to correct bit errors in the user data. This generated extra data is stored along with the user data in the memory media.

Often, the larger the amount of extra data, the more it can enhance data quality. For example, a higher number of parity bits per a given quantity of user data bits can improve error correction and detection capabilities. However, the memory system may have limitations in terms of size, capacity, and other factors that restrict the amount of extra data. Specifically, a reduced memory system size can present challenges in maintaining the quality of user data due to insufficient space for the extra data necessary to ensure this quality. Additionally, it complicates the design of data placement for both user and extra data across the reduced memory system size and/or channels.

Aspects of the present disclosure address the above and other challenges by providing data distribution schemes that effectively manage data placement across a reduced number of channels. Specifically, the embodiments focus on utilizing spaces that would have been reserved in some approaches to provide the placement of both user and extra data within a reduced-channel (e.g., 17 or 18-channel) system. By leveraging these reserved spaces, the disclosed techniques ensure that the quality of the user data is maintained, despite the reduction in the number of channels, thereby overcoming the limitations posed by the reduced memory system size.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. It is to be understood that data can be transferred, read, transmitted, received, or exchanged by electronic signals (e.g., current, voltage, etc.).

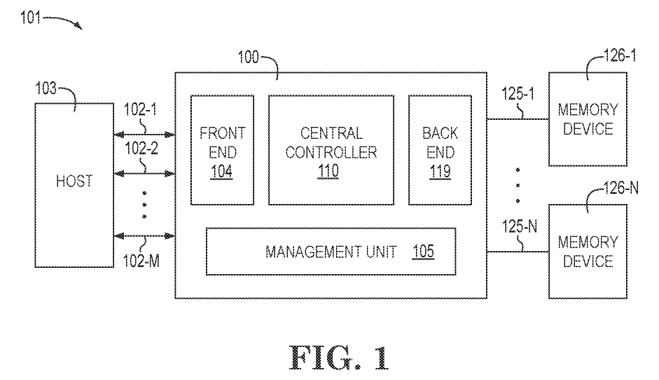

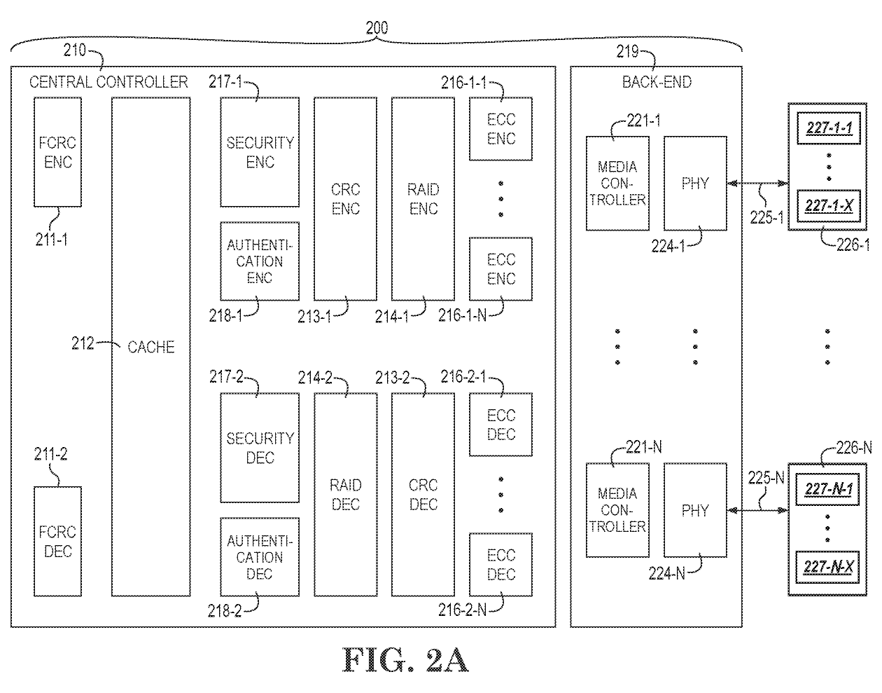

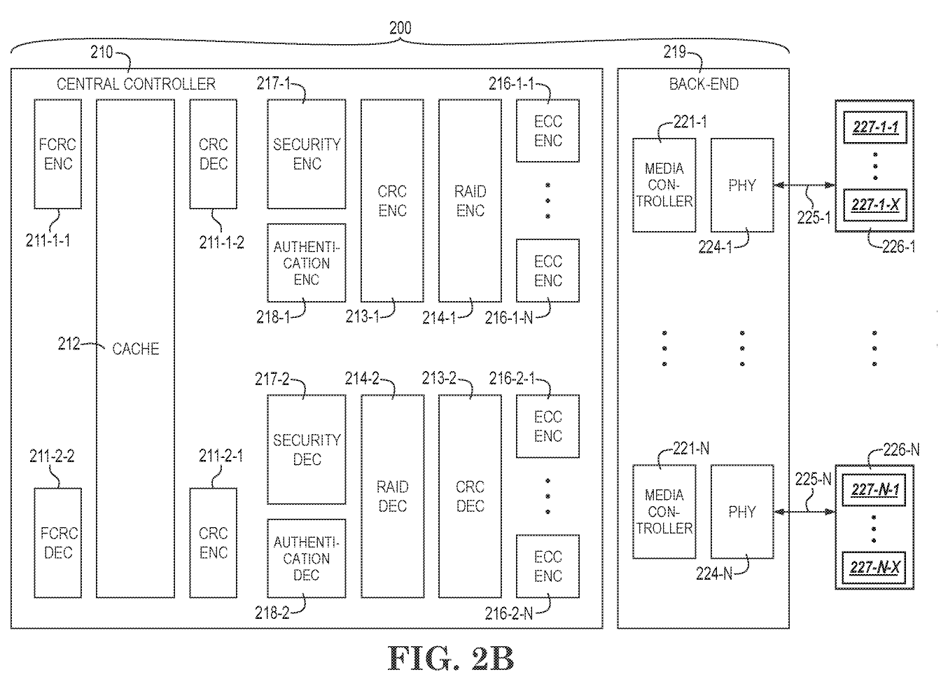

The figures herein follow a numbering convention in which the first digit or digits correspond to the drawing figure number and the remaining digits identify an element or component in the drawing. Similar elements or components between different figures may be identified by the use of similar digits. For example, 126 may reference element “26” in FIG. 1, and a similar element may be referenced as 226 in FIG. 2. Analogous elements within a Figure may be referenced with a hyphen and extra numeral or letter. See, for example, elements 102-1, 102-2, 102-M in FIG. 1. Such analogous elements may be generally referenced without the hyphen and extra numeral or letter. For example, elements 102-1, 102-2, 102-M may be collectively referenced as elements 102. As used herein, the designators “M” and “N”, particularly with respect to reference numerals in the drawings, indicate that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a functional block diagram of a computing system 101 (alternatively referred to as “memory system”) including a memory controller 100 in accordance with a number of embodiments of the present disclosure. The memory controller 100 can include a front end portion 104, a central controller portion 110, and a back end portion 119. The computing system 101 can include a host 103 and memory devices 126-1, …,126-N coupled to the memory controller 100.

The front end portion 104 includes an interface and interface management circuitry to couple the memory controller 100 to the host 103 through input/output (I/O) lanes 102-1, 102-2, …, 102-M and circuitry to manage the I/O lanes 102. There can be any quantity of I/O lanes 102, such as eight, sixteen, or another quantity of I/O lanes 102. In some embodiments, the I/O lanes 102 can be configured as a single port.

In some embodiments, the memory controller 100 can be a compute express link (CXL) compliant memory controller. The host interface (e.g., the front end portion 104) can be managed with CXL protocols and be coupled to the host 103 via an interface configured for a peripheral component interconnect express (PCIe) protocol. CXL is a high-speed central processing unit (CPU)-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall system cost. CXL is designed to be an industry open standard interface for high-speed communications, as accelerators are increasingly used to complement CPUs in support of emerging applications such as artificial intelligence and machine learning. CXL technology is built on the PCIe infrastructure, leveraging PCIe physical and electrical interfaces to provide advanced protocol in areas such as input/output (I/O) protocol, memory protocol (e.g., initially allowing a host to share memory with an accelerator), and coherency interface. As an example, the interface of the front end 104 can be a PCIe 5.0 or 6.0 interface coupled to the I/O lanes 102. In some embodiments, the memory controller 100 can receive access requests involving the memory device 126 via the PCIe 5.0 or 6.0 interface according to a CXL protocol.

The central controller portion 110 can include and/or be referred to as data management circuitry. The central controller portion 110 can control, in response to receiving a request from the host 103, performance of a memory operation. Examples of the memory operation include a read operation to read data from a memory device 126 or a write operation to write data to a memory device 126.

The central controller portion 110 can generate “auxiliary data” to provide data protection scheme on data received from the host 103 and/or other auxiliary data generated at the central controller portion 110. As used herein, the term “auxiliary data” refers to data generated at the memory controller 100 (e.g., the central controller portion 110) and that may not correspond to data received from the host 103 or RAID parity. Although embodiments are not so limited, example auxiliary data can include error correction information (alternatively referred to as error correction data), error detection information (alternatively referred to as error detection data), etc.

An example of an error detection operation that can be performed using error detection information is a cyclic redundancy check (CRC) operation. CRC may be referred to as algebraic error detection. CRC can include the use of a check value resulting from an algebraic calculation using the data to be protected. CRC can detect accidental changes to data by comparing a check value stored in association with the data to the check value calculated based on the data.

An error correction operation (alternatively referred to as error correction code (ECC) operation) performed using the error correction information can correct an amount of bit errors and/or detect an amount of bit errors that may have not been corrected using the ECC operation. Error correction information used to perform the ECC operation can be parity data (alternatively referred to as “ECC bits” or “ECC data”), which are generated by comparing (e.g., XORing) at least a portion of rows (e.g., bit patterns) of encoding matrix (alternatively referred to as a parity matrix) that respectively correspond to bits of data (e.g., data received from the host 103 and/or other auxiliary data generated at the central controller portion 110) having a particular value.

The back end portion 119 can include a media controller and a physical (PHY) layer that couples the memory controller 100 to the memory devices 126. As used herein, the term “PHY layer” generally refers to the physical layer in the Open Systems Interconnection (OSI) model of a computing system. The PHY layer may be the first (e.g., lowest) layer of the OSI model and can be used transfer data over a physical data transmission medium. In some embodiments, the physical data transmission medium can include channels 125-1, …, 125-N. The channels 125 can include various types of data buses, such as a eight-pin data bus (e.g., data input/output (DQ) bus) and a one-pin data mask inversion (DMI) bus, among other possible buses.

The memory devices 126 can be various/different types of memory devices. For instance, the memory device can include an array RAM, ROM, DRAM, SDRAM, PCRAM, RRAM, and flash memory cells, among others. In embodiments in which the memory device 126 includes persistent or non-volatile memory, the memory device 126 can be flash memory devices such as NAND or NOR flash memory devices. Embodiments are not so limited, however, and the memory device 126 can include an array of other non-volatile memory cells such as non-volatile random-access memory cells (e.g., non-volatile RAM (NVRAM), ReRAM, ferroelectric RAM (FeRAM), MRAM, PCRAM), “emerging” memory cells such as a ferroelectric RAM cells that includes ferroelectric capacitors that can exhibit hysteresis characteristics, a memory device with resistive, phase-change, or similar memory cells, etc., or combinations thereof.

As an example, a FeRAM device (e.g., a memory device 126 include an array of FeRAM cells) can include ferroelectric capacitors and can perform bit storage based on an amount of voltage or charge applied thereto. In such examples, relatively small and relatively large voltages allow the ferroelectric RAM device to exhibit characteristics similar to normal dielectric materials (e.g., dielectric materials that have a relatively high dielectric constant) but at various voltages between such relatively small and large voltages the ferroelectric RAM device can exhibit a polarization reversal that yields non-linear dielectric behavior.

In another example, the memory devices 126 can be a dynamic random access memory (DRAM) device (e.g., the memory device 126 including an array of DRAM cells) operated according to a protocol such as low-power double data rate (LPDDRx), which may be referred to herein as LPDDRx DRAM devices, LPDDRx memory, etc. The “x” in LPDDRx refers to any of a number of generations of the protocol (e.g., LPDDR5). In at least one embodiment, at least one of the memory devices 126-1 is operated as an LPDDRx DRAM device with low-power features enabled and at least one of the memory devices 126-N is operated an LPDDRx DRAM device with at least one low-power feature disabled. In some embodiments, although the memory devices 126 are LPDDRx memory devices, the memory devices 126 do not include circuitry configured to provide low-power functionality for the memory devices 126 such as a dynamic voltage frequency scaling core (DVFSC), a sub-threshold current reduce circuit (SCRC), or other low-power functionality providing circuitry. Providing the LPDDRx memory devices 126 without such circuitry can advantageously reduce the cost, size, and/or complexity of the LPDDRx memory devices 126. By way of example, an LPDDRx memory device 126 with reduced low-power functionality providing circuitry can be used for applications other than mobile applications (e.g., if the memory is not intended to be used in a mobile application, some or all low-power functionality may be sacrificed for a reduction in the cost of producing the memory).

Data can be communicated between the back end portion 119 and the memory devices 126 primarily in forms of one or more data blocks. For example, the one or more data blocks can be transferred to/from (e.g., written to/read from) the memory devices 126 via the channels 125 over a predefined burst length (e.g., a 16-bit or 32-bit BL) that the memory controller 100 operates with. As further described herein, a data block can be in a plain text or cypher text form depending on whether the data block has been encrypted at the memory controller 100 (e.g., the security encoder 217-1 illustrated in FIGS. 2A and 2B). The data block can be a unit of read and/or write access to the memory device 126.

Data blocks can include a user data block (UDB). As used herein, the term “UDB” refers to a data block containing host data (e.g., received from the host 103 and alternatively referred to as “user data”).

A burst is a series of data transfers over multiple cycles, such as beats. As used herein, the term “beat” refers to a clock cycle (or at least a portion of the clock cycle) increment during which an amount of data equal to the width of the memory bus may be transmitted. In an example of data transfers involves a double data rate (DDR), each clock cycle may include two beats of data transfers. For example, 32-bit burst length can be made up of 32 beats of data transfers, while 16-bit burst length can be made up of 16 beats of data transfers. Although embodiments are not so limited, a bus width corresponding to a size of each beat can be 8 or 16 (e.g., alternatively referred to as “x8” and “x16”, respectively).

Along with the UDB, the data block can also include other “extra” bits of data (e.g., other data in addition to data corresponding to an UDB and alternatively referred to as “auxiliary data”) that can also be transferred between the back end portion 119 and the memory devices 126. The extra data can include data used to correct and/or detect errors in UDB and/or at least a portion of auxiliary data, authenticate and/or check data integrity of the UDB and/or metadata, etc. although embodiments are not so limited. In one example, a data block having a size of 70 bytes can include an UDB having a size of 64 bytes as well as 6 bytes of auxiliary data. In another example, a data block having a size of 72 bytes can include an UDB having a size of 64 bytes as well as 8 bytes of auxiliary data. Further details of the extra bits are illustrated and described in connection with FIGS. 2-5.

In some embodiments, some (e.g., one or more) memory devices 126 can be dedicated for auxiliary data. For example, memory devices configured to store UDBs can be different from a memory device (e.g., one or more memory devices) configured to store auxiliary data.

In some embodiments, the memory controller 100 can include a management unit 105 to initialize, configure, and/or monitor health of the memory devices 126 (e.g., DRAM) and/or characteristics of the memory controller 100. The management unit 105 can include an I/O bus to manage out-of-band data and/or commands, a management unit controller to execute instructions associated with initializing, configuring, and/or monitoring the characteristics of the memory controller, and a management unit memory to store data associated with initializing, configuring, and/or monitoring the characteristics of the memory controller 100. As used herein, the term “out-of-band” generally refers to a transmission medium that is different from a primary transmission medium of a network. For example, out-of-band data and/or commands can be data and/or commands transferred to a network using a different transmission medium than the transmission medium used to transfer data within the network.

FIG. 2A is a functional block diagram of a memory controller 200 for cache line data protection in accordance with a number of embodiments of the present disclosure. The memory controller 200, the central controller portion 210, the back end portion 219, and the memory devices 226 illustrated in FIG. 2A are analogous to the memory controller 100, the central controller portion 210, the back end portion 119, and the memory devices 126 illustrated in FIG. 1.

The central controller portion 210 includes a front-end CRC (“FCRC”) encoder 211-1 (e.g., paired with a FCRC decoder 211-2) to generate error detection information (e.g., alternatively referred to as end-to-end CRC (e2e CRC)) based on data (e.g., an UDB in “plain text” form) received as a part of a write command (e.g., received from the host 103) and before writing the data to the cache 212. As used herein, an UDB in plain text form can be alternatively referred to as an “unencrypted UDB”, which can be further interchangeably referred to as a “decrypted UDB” or an “unencrypted version of an UDB”. The error detection information generated at the FCRC encoder 211-1 can be a check value, such as CRC data. Read and write commands of CXL memory systems can be a size of UDB, such as 64 bytes. Accordingly, the data received at the FCRC encoder 211-1 can correspond to a UDB.

The central controller portion 210 includes a cache 212 to store data (e.g., user data), error detection information, error correction information, and/or metadata associated with performance of the memory operation. An example of the cache 212 is a thirty-two (32) way set-associative cache including multiple cache lines. While host read and write commands can be a size of an UDB (e.g., 64 bytes), the cache line size can be greater than a size of an UDB (e.g., equal to a size of multiple UDBs). For example, the cache line size can correspond to a size of 2 UDBs (with each UDB being a 64-byte chunk), such as 128 bytes, although embodiments are not so limited.

These UDBs stored in each cache line (e.g., alternatively referred to as “UDBs corresponding to a cache line”) can be a data transfer unit of data paths between the cache 212 and the memory devices 226. For example, even though a host read/write command is a size of an UDB, such as 64 bytes, the UDBs corresponding to a cache line can be collectively transferred between the cache 212 and the memory devices 226 (e.g., through other encoder/decoder illustrated in FIG. 2A) as a chunk. Therefore, the UDBs corresponding to a cache line can be collectively encrypted/decrypted at various encoder/decoders illustrated in FIG. 2A and located between the cache 212 and the memory devices 226. UDBs corresponding to a cache line can be further correspond to a same channel 225. For example, the UDBs corresponding to a cache line can be written to/stored in a same memory device.

Data (e.g., one or more UDBs) stored in (e.g., a respective cache line of) the cache 212 can be further transferred to the other components (e.g., a security encoder 217-1 and/or an authenticity/integrity check encoder 218-1, which is shown as “AUTHENTICITY/INTEGRITY ENC” 218-1) of the central controller portion 210 (e.g., as part of cache writing policies, such as cache writeback and/or cache writethrough) to be ultimately stored in the memory devices 226 to synchronizes the cache 212 and the memory devices 226 in the event that the data received from the host (e.g., the host 103 illustrated in FIG. 1) have not been written to the memory devices 226 yet.

Use of the cache 212 to store data associated with a read operation or a write operation can increase a speed and/or efficiency of accessing the data because the cache 212 can prefetch the data and store the data in multiple 64-byte blocks in the case of a cache miss. Instead of searching a separate memory device in the event of a cache miss, the data can be read from the cache 212. Less time and energy may be used accessing the prefetched data than would be used if the memory system has to search for the data before accessing the data.

The central controller portion 210 further includes a security encoder 217-1 (e.g., paired with a security decoder 217-2) to encrypt data (e.g., UDBs corresponding to a cache line) before transferring the data to a CRC encoder 213-1 (to write the data to the memory devices 226). Although embodiments are not so limited, the pair of security encoder/decoder 217 can operate using an AES encryption/decryption (e.g., algorithm). Unencrypted data (e.g., plain text) can be converted to cypher text via encryption by the security encoder 217-1. As used herein, the UDB in cypher text form can be alternatively referred to as an “encrypted UDB”, which can be alternatively referred to as an “encrypted version of an UDB”. The central controller portion 210 further includes an authenticity/integrity check encoder 218-1 to generate authentication data based on data received from the cache 212. Although embodiments are not so limited, the authentication data generated at the authenticity/integrity check encoder 218-1 can be MAC, such as KECCAK MAC (KMAC) (e.g., SHA-3-256 MAC).

In some embodiments, the MAC generated at the authenticity/integrity check encoder 218-1 can be calculated based on trusted execution environment (TEE) data (alternatively referred to as “TEE flag”), Host Physical Address (HPA) (e.g., a memory address used/identified by the host 103 illustrated in FIG. 1 in association with host read/write transactions), a security key identifier (ID) that are associated with a physical address (of the memory devices 226) to be accessed for executing a host write command.

The security encoder 217-1 and the authenticity/integrity check encoder 218-1 can operate in parallel. For example, the data stored in the cache 212 and that are in plain text form can be input (e.g., transferred) to both the security encoder 217-1 and the authenticity/integrity check encoder 218-1. In some embodiments, a security key ID can be further input (along with the data in plain text form) to the security encoder 217-1. Further, in some embodiments, a security key ID, TEE flag, and an HPA associated with a host write command can be further input (along with the data in plain text form) to the authenticity/integrity check encoder 218-1.

The central controller portion 210 includes a CRC encoder 213-1 (e.g., paired with a CRC decoder 213-2) to generate error detection information (e.g., alternatively referred to as CRC media (CRCm)) based collectively on UDBs corresponding to a cache line received from the security encoder 217-1. The data transferred to the CRC encoder 213-1 from the security encoder 217-1 can be in cypher text form as the data were previously encrypted at the security encoder 217-1. The error detection information generated at the error detection information generator 213-1 can be a check value, such as CRC data. The CRC encoder 213-1 and CRC decoder 213-2 can operate on data having a size equal to or greater than a cache line size.

The central controller portion 210 includes RAID encoder 214-1 (e.g., paired with a RAID decoder 214-2) to generate and/or update RAID parity data (alternatively referred to as a parity data block, “PDB”) based at least in part on data (e.g., one or more UDBs corresponding to a cache line) received from the CRC encoder 213-1. The data transferred to the RAID encoder 214-1 from the CRC encoder 213-1 can be in cypher text form as the data were encrypted at the security encoder 217-1.

The RAID encoder 214-1 can update the PDB to conform to new UDB received as part of a write command from the host. To update the PDB, an old UDB (that is to be replaced with the new UDB) and an old PDB (of a same stripe as the old UDB) can be read (e.g., transferred to the RAID encoder 214-1) and compared (e.g., XORed) with the new UDB, and a result of the comparison (e.g., the XOR operation) can be further compared (e.g., XORed) with an old PDB (that is to be updated) to result in a new (e.g., updated) PDB.

As shown in FIG. 2A, the central controller portion 210 can include ECC encoders 216-1-1, …, 216-1-N. Each ECC encoder 216-1 can be configured to generate ECC data (alternatively referred to as “error correction information”) based collectively on data (e.g., UDBs corresponding to a cache line) transferred from the RAID encoder 214-1. The data transferred to each ECC encoder 216-1 can be in cypher text form as the data were previously encrypted at the security encoder 217-1.

Each ECC encoder 216-1 can correspond to a respective channel 226/memory device 226. Accordingly, UDBs corresponding to a cache line and transferred to one ECC encoder 216-1-1 (where ECC data are generated based on the UDBs) can be transferred and written to a respective memory device 226 (e.g., the memory device 226-1) along with the ECC data.

Each ECC encoder 216-1 can be paired with a respective one of ECC decoders 216-2-1, …, 216-2-N to operate in a collective manner and to be dedicated for each memory device 216. For example, an ECC encoder 216-1-1 that can be responsible for the memory device 226-1 can be paired with an ECC decoder 216-2-1 that is also responsible for the memory device 226-1, which allows ECC data that were generated at the ECC encoder 216-1-1 and are to be later transferred to the ECC decoder 216-2-1 to be stored in the memory device 226-1.

“Extra” bits of data (alternatively referred to as auxiliary data) can be transferred (along with the UDBs) to the back end portion 219 to be ultimately transferred and written to the memory devices 226. The auxiliary data can include error detection information (e.g., CRC data) generated at the FCRC encoder 211-1 and/or 213-1, error correction information (e.g., alternatively referred to as ECC data) generated at the ECC encoders 216-1, and/or authentication data (e.g., MAC data) generated at the authenticity/integrity check encoder 218-1 that are associated with the UDBs as well as metadata and/or TEE data. Furthermore, RAID parity data (e.g., in forms of a PDB) generated at the RAID 214-1 can be also written to the memory devices 226 along with the UDBs and auxiliary data.

As shown in FIG. 2A, the memory controller 200 can include a back end portion 219 coupled to the central controller portion 210. The back end portion 219 can include media controllers 221-1, …, 221-N. The back end portion 219 can include PHY memory interfaces 224-1, …, 224-N. Each physical interface 224 is configured to be coupled to a respective memory device 226.

The media controllers 221-1, …, 221-N can be used substantially contemporaneously to drive the channels 225-1, …, 225-N concurrently. In at least one embodiment, each of the media controllers 221 can receive a command and address and drive the channels 225 substantially contemporaneously. By using the same command and address, each of the media controllers 221 can utilize the channels 225 to perform the same memory operation on the same memory cells.

As used herein, the term “substantially” means that the characteristic need not be absolute, but is close enough so as to achieve the advantages of the characteristic. For example, “substantially contemporaneously” is not limited to operations that are performed absolutely contemporaneously and can include timings that are intended to be contemporaneous but due to manufacturing limitations may not be precisely contemporaneously. For example, due to read/write delays that may be exhibited by various interfaces (e.g., LPDDR5 vs. PCIe), media controllers that are utilized “substantially contemporaneously” may not start or finish at exactly the same time. For example, the memory controllers can be utilized such that they are writing data to the memory devices at the same time regardless of whether one of the media controllers commences or terminates prior to the other.

The PHY memory interfaces 224 can be an LPDDRx memory interface. In some embodiments, each of the PHY memory interfaces 224 can include data and DMI pins. For example, each PHY memory interface 224 can include sixteen data pins and two DMI pins. The media controllers 221 can be configured to exchange data with a respective memory device 226 via the data pins. The media controllers 221 can be configured to exchange error correction information (e.g., ECC data), error detection information, and or metadata via the DMI pins as opposed to exchanging such information via the data pins. The DMI pins can serve multiple functions, such as data mask, data bus inversion, and parity for read operations by setting a mode register. The DMI bus uses a bidirectional signal. In some instances, each transferred byte of data has a corresponding signal sent via the DMI pins for selection of the data. In at least one embodiment, the data can be exchanged contemporaneously with the error correction information and/or the error detection information. For example, 256 bytes of data (e.g., UDBs corresponding to a cache line) can be exchanged (transmitted or received) via the data pins while 256 bits of the extra bits are exchanged via the DMI pins, although embodiments are not so limited. Such embodiments reduce what would otherwise be overhead on the data input/output (e.g., also referred to in the art as a “DQ”) bus for transferring error correction information, error detection information, and/or metadata.

The back end portion 219 can couple the PHY memory interfaces 224-1, …, 224-N to respective memory devices 226-1, …, 226-N. The memory devices 226 each include at least one array of memory cells. In some embodiments, the memory devices 226 can be different types of memory. The media controllers 221 can be configured to control at least two different types of memory. For example, the memory device 226-1 can be LPDDRx memory operated according to a first protocol and the memory device 226-N can be LPDDRx memory operated according to a second protocol different from the first protocol. In such an example, the first media controller 221-1 can be configured to control a first subset of the memory devices 226-1 according to the fist protocol and the second media controller 221-N can be configured to control a second subset of the memory devices 226-N according to the second protocol.

Data (UDBs corresponding to a cache line) stored in the memory devices 226 can be transferred to the back end portion 219 to be ultimately transferred and written to the cache 212 and/or transferred to the host (e.g., the host 103 illustrated in FIG. 1). In some embodiments, the data are transferred in response to a read command to access a subset of the data (e.g., one UDB) and/or to synchronize the cache 212 and the memory devices 226 to clean up “dirty” data in the cache 212.

Along with the UDBs, auxiliary data can be transferred to the back end portion 219 as well. The auxiliary data can include, error detection information generated at the FCRC encoder 211-1 and/or 213-1, ECC data generated at the ECC encoders 216-1, and authentication data generated at the authenticity/integrity check encoder 218-1 that are associated with the UDBs as well as metadata and/or TEE data. As described herein, the UDBs transferred to the back end portion 219 can be in cypher text form.

Data (e.g., UDBs corresponding to a cache line) transferred to the back end portion 219 can be further transferred to the respective ECC decoders 216-2. At each ECC decoder 216-2, an error correction operation can be performed on the data to correct error(s) up to a particular quantity and detect errors beyond particular quantity without correcting those. In one example, each ECC decoder 216-2 can use the error correction information (e.g., ECC data) to either correct a single error or detect two errors (without correcting two errors), which is referred to as a single error correction and double error detection (SECDED) operation. In another example, each ECC decoder 216-2 can use the error correction information to either correct a two error or detect three errors (without correcting three errors), which is referred to as a double error correction and triple error detection (DECTED) operation.

As described herein, each ECC decoder 216-2 can also be responsible for a respective memory device 226 as the paired ECC encoder 216-1 is. For example, if the ECC decoder 216-2-1 is responsible for the memory device 226-1, the ECC data and the UDBs stored in the memory device 226-1 can be transferred to the ECC decoder 216-2-1. In some embodiments, pairs of ECC encoder/decoder 216 can be selectively enabled/disabled to transfer data between the memory devices 226 and the memory controller 200 without generating error correction information (e.g., ECC data) and/or performing an error correction operation using the pairs.

Subsequent to error correction operations performed (e.g., on the data transferred to the ECC decoders 216-2 including error detection information previously generated at the CRC encoder 213-1) respectively at the ECC decoders 216-2, the UDBs can be further transferred to the CRC decoder 213-2 along with at least the error detection information previously generated at the CRC encoder 213-1. At the CRC decoder 213-2, an error detection operation can be performed to detect any errors in the UDBs using the error detection information, such as CRC data.

The CRC decoder 213-2 can operate on data in conjunction with the RAID decoder 214-2 to provide check-and-recover correction. More specifically, the CRC decoder 213-2 can detect an error in data (e.g., received from the respective ECC decoder 216-2) and the RAID decoder 214-2 can recover the data in response. In at least one embodiment, the check-and-recover correction provided by the error detection circuitry 211 and the RAID decoder 214-2 is supplemental to the error correction provided by the ECC decoder 216-2. For example, if data (e.g., UDBs corresponding to a cache line) transferred from the memory devices 226 has an error correctable by the ECC decoder 216-2, it can do so without further data recovery (e.g., one or more RAID operations) by the RAID decoder 214-2. However, if an error persists that is not correctable by the ECC decoder 216-2, then the data may be recoverable by the RAID decoder 214-2. As another example, an error may escape detection by the ECC decoder 216-2, but be detected by the CRC decoder 213-2. In such an example, the underlying data may be recoverable by the RAID decoder 214-2.

When the RAID process is triggered by the RAID decoder 214-2 to recover one UDB (that were checked for errors at the respective CRC decoder 213-2), the other UDBs and PDBs belong to same stripe as the UDB to be recovered can be transferred to the RAID decoder 214-2 where one or more RAID operations are performed. In some embodiments, the RAID decoder 214-2 can further include a CRC decoder that provides the same functionality as the CRC decoder 213-2, but to perform an error detection operation (e.g., to CRC-check) on data subsequent to the RAID process.

The data (e.g., UDBs corresponding to a cache line) can be further transferred to the security decoder 217-2 and to the authenticity/integrity check decoder 218-2 (shown as “AUTHENTICITY/INTEGRITY DEC” 218-2 in FIG. 2A) along with at least the authentication data previously generated at the authenticity/integrity check encoder 218-1. At the security decoder 217-2, the data can be decrypted (e.g., converted from the cypher text back to the plain text as originally received from the host). The security decoder 217-2 can use an AES decryption to decrypt the data.

At the authenticity/integrity check decoder 218-2, the data that were decrypted at the security decoder 217-2 can be authenticated (and/or checked for data integrity) using the authentication data (e.g., MAC data) that were previously generated at the authenticity/integrity check encoder 218-1. In some embodiments, the authenticity/integrity check decoder 218-2 can calculate MAC based on TEE data, HPA, and the security key ID associated with a physical address to be accessed for executing a host read command. The MAC that is calculated during the read operation can be compared to the MAC transferred from (a location corresponding to the physical address of) the memory devices 226. If the calculated MAC and transferred MAC match, the UDB is written to the cache 212 (and further transferred to the host if needed). If the calculated MAC and transferred MAC do not match, the host is notified of the mismatch (and/or the poison).

The data (e.g., UDBs corresponding to a cache line) authenticated (and/or checked for data integrity) at the authenticity/integrity check decoder 218-2 can be transferred and written to the cache 212. In some embodiments, data can be further transferred from the cache 212 to the FCRC decoder 211-2, for example, in response to a read command received from the host (e.g., the host 103 illustrated in FIG. 1). As described herein, host read and write commands of CXL memory systems can be a size of UDB, such as 64 bytes. For example, data can be requested by the host in a granularity of an UDB. In this example, even if data transferred from the memory devices 226 are multiple UDBs (corresponding to a cache line), data can be transferred from the cache 212 to the host in a granularity of an UDB. At the FCRC decoder 211-2, data (e.g., an UDB requested by the host) can be checked (CRC-checked) for any errors using CRC data that were previously generated at the FCRC encoder 211-1. The data decrypted at the FCRC decoder 211-2 can be further transferred to the host.

FIG. 2B is another functional block diagram of a memory controller 200 for cache line data protection in accordance with a number of embodiments of the present disclosure. The memory controller 200, the central controller portion 210, the back end portion 219, and the memory devices 226 illustrated in FIG. 2B are analogous to the memory controller 100, the central controller portion 110, the back end portion 119, and the memory devices 126 illustrated in FIG. 1.

The memory controller 200 can include a central controller portion 210, and a back end portion 219. The central controller portion 210 can include a front-end CRC (“FCRC”) encoder 211-1-1 paired with a FCRC decoder 211-1-2 and a FCRC encoder 211-2-1 paired with a FCRC decoder 211-2-2, the cache memory 212 coupled between the paired CRC encoder/decoder 211-1 and CRC encoder/decoder 211-2, the security encoder 217-1 paired with the security decoder 217-2, the authenticity/integrity check encoder 218-1 (shown as “AUTHENTICITY/INTEGRITY ENC” 218-1 in FIG. 2B) paired with the authenticity/integrity check decoder 218-2 (shown as “AUTHENTICITY/INTEGRITY DEC” 218-2 in FIG. 2B), the CRC encoder 213-1 paired with the CRC decoder 213-2, the RAID encoder 214-1 paired with the RAID decoder 214-2, and the ECC encoders 216-1-1, …, 216-1-N respectively paired with the ECC decoders 216-2-1, …, 216-2-N. A pair of security encoder/decoder 217, a pair of authenticity/integrity check encoder/decoder 218, a pair of CRC encoder/decoder 213, a pair of RAID 214, respective pairs of ECC encoder/decoder 216 can be analogous to a pair of security encoder/decoder 217, a pair of authenticity/integrity check encoder/decoder 218, a pair of CRC encoder/decoder 213, a pair of RAID 214, respective pairs of ECC encoder/decoder 216, as illustrated in FIG. 2A. Although not illustrated in FIG. 2B, the RAID decoder 214-2 can further include a CRC decoder that provides the same functionality as the CRC decoder 213-2, but to perform an error detection operation (e.g., to CRC-check) on data subsequent to the RAID process.

The back end portion 219 can include media controllers 221-1, …, 221-N. The PHY layer 224 can include PHY memory interfaces 224-1, …, 224-N configured to be coupled to memory devices 226-1, …, 226-N via channels 225-1, …, 225-N.

FIG. 2B is analogous to FIG. 2A, except that it includes additional circuitry to check any errors on the UDB using CRC data without transferring/storing the FCRC data to the memory device 226. For example, as illustrated in FIG. 2B, the FCRC decoder 211-1-2 coupled between the cache 212 and the security encoder 217-1 (and/or the authenticity/integrity check encoder 218-1) can be configured to check any errors on an UDB stored in the cache 212 using error detection information (e.g., CRC data) generated at the FCRC encoder 211-1-1. The FCRC encoder 211-2-1 coupled between the cache 212 and the security decoder 217-2 (and/or the authenticity/integrity check decoder 218-2) can be configured generate error detection information (e.g., CRC data) on an UDB to be transferred to the host (e.g., the host 103 illustrated in FIG. 1). The error detection information generated at the FCRC encoder 211-2-1 can be used at the FCRC decoder 211-2-2 to check any errors on an UDB transferred from the cache 212.

In some embodiments, the pairs of CRC encoder/decoder 211-1 and 211-2 can be used just to check errors on data stored in the cache. Accordingly, error detection information used at the pairs 211-1 and 211-2 may not be transferred and written to the memory devices 226.

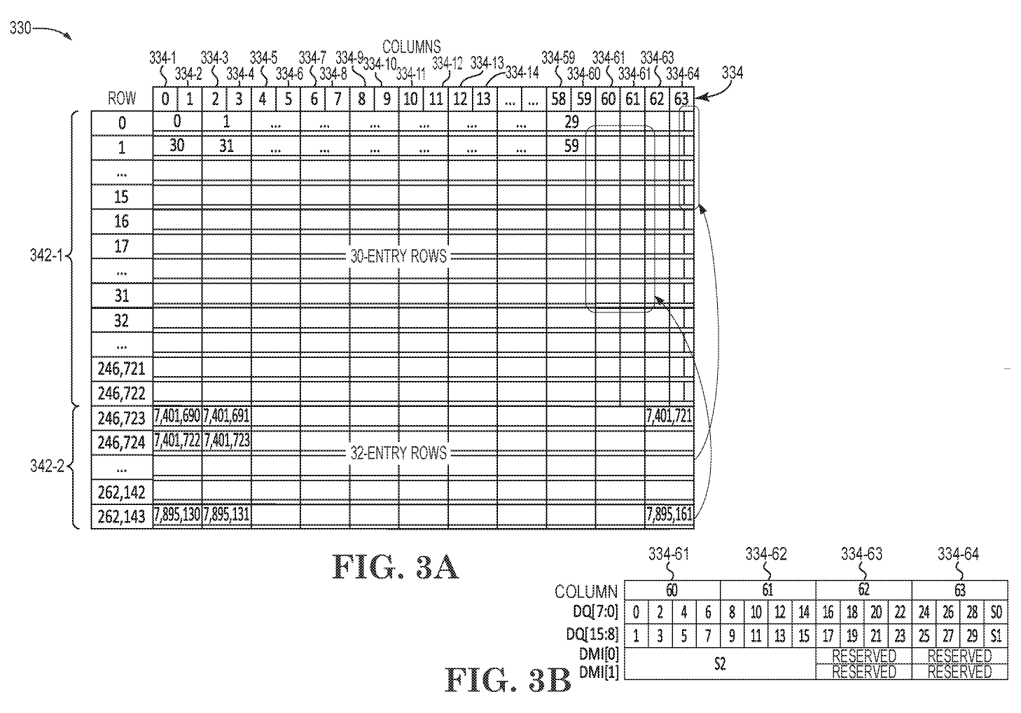

FIG. 3A schematically illustrates an example of data placement on memory dice in accordance with a number of embodiments of the present disclosure. Each row illustrated in FIG. 3B can be a “virtual” row (e.g., virtually represented as a single row), which can be formed from multiple memory dice (e.g., 227-1-1, …, 227-1-X or 227-N-1, …, 227-N-X). For example, a portion (e.g., half) of each column selection can be from one memory die, while another portion (e.g., another half) of each column selection can be from a different memory die. Although embodiments are not so limited, the memory dice of which the number of rows can be part can correspond to (be part of) the same channel, such as channel 125-1, 225-1 illustrated in FIGS. 1, 2A, and 2B. Although FIG. 3A illustrates “262,143” rows, “7,895,161” UDBs, “63” column selections, embodiments are not limited to those particular quantities of rows, UDBs, and column selections that can be included in the embodiments of the present disclosure (e.g., embodiments shown in FIG. 3A).

Each row of the one or more memory dice is partitioned into “column selections”, such as column selections 334-1, …, 334-63 (respectively corresponding to column selections “0” to “63” shown on 334 of table 330 illustrated in FIG. 3). Each pair of column sections can be part of a burst length, such as a 32-bit burst length. Alternatively speaking, each column section corresponds to a quantity of bits that can be exchanged with (e.g., transferred out of) the memory dice over one predefined burst length, such as a 32-bit burst length.

As an example, as illustrated in FIG. 3A, the pair of column selections “0” and “1” of the row “0” can correspond to a 32-bit burst length and can (e.g., be configured to) store data “0”; the pair of column selections “2” and “3” of the row “0” can correspond to a 32-bit burst length and can (e.g., be configured to) store data “1”; …; and the pair of column selections “58” and “59 of the row “0” can correspond to a 32-bit burst length and can (e.g., be configured to) store data “29”. As used herein, each pair of column sections that correspond to the 32-bit burst length can be referred to as “column entry”.

Although embodiments are not so limited, each column selection is distributed over different memory dice, such as two memory dice (e.g., two memory dice 227). Accordingly, data transfer corresponding to each column selection includes data transfer from two memory dice. Given that each memory die includes 8 DQ pins and 2 DMI pins (, the data transfer from a single column selection over the 32-bit burst length via DQ pins can be 64 bytes (e.g., 32 bytes from each memory die), while the data transfer over the 32-bit burst length via DMI pins can be 4 bytes (e.g., 2 bytes from each memory die). Therefore, data transfer corresponding to the 32-bit burst length can include data transfer of 128 bytes and 8 bytes respectively via DQ pins and DMI pins over the 32-bit burst length.

As further illustrated in FIG. 3B, each row can include a “DQ portion” and a “DMI portion”. As used herein, the term “DQ portion” refers to a portion of the respective row of memory cells that exchanges data via one or more DQ pins (“DQ[7:0]”, “DQ[15:8]” illustrated in FIG. 3B), while the term “DMI portion” refers to a portion of the respective row of memory cells that exchanges data via one or more DMI pins (“DMI[0]”, “DMI[1]” illustrated in FIG. 3B).

A first portion 342-1 of rows of memory cells illustrated in FIG. 3A can each (e.g., be configured to) store 30 UDBs with each UDB having a size of 64B. Alternatively speaking, thirty column entries (e.g., corresponding to column selections “0” to “59”) of each row of the first portion 342-1 can (e.g., be configured to) store 30 UDBs, respectively. As an example, the row “0” can be configured to store thirty UDBs “0”, …, “29” (over column selections “0”, …, “59”), while the row “1” can be configured to store another thirty UDBs “30”, …, “59” (over column selections “0”, …, “59”).

Further, a second portion 342-2 of rows of memory cells illustrated in FIG. 3A can (e.g., be configured to) store 32 UDBs with each UDB having a size of 64B. Alternatively speaking, thirty-two column entries (e.g., corresponding to column selections “0” to “63”) of each row of the second portion 234-2 can (e.g., be configured to) store 32 UDBs, respectively. As an example, the row “246,723” can be configured to store thirty UDBs “7,401,690”, …, “7,401,721” (over column selections “0”, …, “59”), while the row “262,143” can be configured to store another third UDBs “7,895,130”, …, “7,895,161” (over column selections “0”, …, “59”).

As further illustrated in FIG. 3A, two column entries (e.g., one column entry including column selections “60” and “61” and another column entry including column selections “62” and “63”) of each row of the first portion 342-1 can (e.g., be configured to) store auxiliary data of those UDBs stored in a respective row of the first portion 342-1 or the second portion 342-2. As described herein, the auxiliary data can include error detection information (e.g., CRC data) generated at the FCRC encoder 211-1 and/or 213-1 of FIG. 2A, error correction information (e.g., alternatively referred to as ECC data) generated at the ECC encoders 216-1, and/or authentication data (e.g., MAC data) generated at the authenticity/integrity check encoder 218-1 that are associated with the UDBs as well as metadata and/or TEE data.

FIG. 3B further illustrates data placement of the auxiliary data on the column selections 334-61 (“60”), 334-62 (“61”), 334-63 (“62”), and 334-64 (“64”) of the row “0” of the first portion 342-1. As illustrated in FIG. 3B, the DQ portions (“DQ[7:0]” and “DQ[15:8]”) of each column selection are configured to store auxiliary data corresponding to UDBs stored in row “0”. FIG. 3B is presented as a representation for each row of the first portion 342-1 of the memory dice 227, without necessarily limiting the illustration to row “0”.

For example, each segment (e.g., respectively indicated as “0”, “2”, “4”, “6” as shown in FIG. 3B) of a respective DQ portion (e.g., via which data can be exchanged using “DQ[7:0]”) of the row “0” corresponding to the column selection 334-61 can be configured to store auxiliary data corresponding to UDBs “0” (stored in a portion of the row “0” corresponding to the column entry having column selections “0” and “1”), “2” (stored in a portion of the row “0” corresponding to the column entry having column selections “4” and “5”), “4” (stored in a portion of the row “0” corresponding to the column entry having column selections “8” and “9”), “6” (stored in a portion of the row “0” corresponding to the column entry having column selections “12” and “13”), respectively and as shown in FIG. 3A.

For example, each segment (e.g., respectively indicated as “1”, “3”, “5”, “7”) of a respective DQ portion (e.g., via which data can be exchanged using “DQ[15:8]” of two memory dice) of the row “0” corresponding to the column selection 334-61 can be configured to store auxiliary data corresponding to UDBs “1” (stored in a portion of the row “0” corresponding to the column entry having column selections “2” and “3”), “3” (stored in a portion of the row “0” corresponding to the column entry having column selections “6” and “7”), “5” (stored in a portion of the row “0” corresponding to the column entry having column selections “10” and “11”), “7” (stored in a portion of the row “0” corresponding to the column entry having column selections “14” and “15” not shown in FIG. 3A), respectively and as shown in FIG. 3A. In a similar manner, auxiliary data corresponding to UDBs “0” to “29” can be respectively stored in the DQ portions of the column selections 334-61, 334-62, 334-63, 334-64 as shown in FIG. 3B. Although embodiments are not so limited, each segment (“0”, …, “29” shown in FIG. 3B) can have a size of 4 bytes.

Along with auxiliary data (e.g., auxiliary data “0”, …, “29”) shown in FIG. 3B, each UDB (e.g., UDB “0”, …, “7,895,161”) can also have its other portion of auxiliary data stored in the same column selections as the respective UDB. For example, an UDB “0” stored in memory cells corresponding to the row “0” and column selections “0” and “1” can have its first portion (e.g., 4 bytes) of auxiliary data stored in a DMI portion of the row “0” corresponding to the column selection “0” and “1” and its second portion (e.g., 4 bytes) of the auxiliary data stored in a DQ portion of the row “0” corresponding to the column selection “60”.

For example, a UDB “0” stored in memory cells corresponding to row “0” and column selections “0” and “1” can have its first portion (e.g., 4 bytes) of auxiliary data stored in the DMI portion of row “0” corresponding to column selections “0” and “1”, and its second portion (e.g., 4 bytes) of auxiliary data stored in the DQ portion of row “0” corresponding to column selection “60”.

A portion of each row of the first portion 342-1 of the memory dice 227 can be also configured to store auxiliary data of those UDBs stored in respective rows of the second portion 342-2 of the memory dice 227. For example, as illustrated in FIG. 3B, “S0” (e.g., 4 bytes) can be a (e.g., half) portion of auxiliary data corresponding to one UDB stored in the respective row of the second portion 342-2; “S1” (e.g., 4 bytes) can be a (e.g., half) portion of auxiliary data corresponding to one UDB stored in the respective row of the second portion 342-2; and “S2” (e.g., 4 bytes) can be a (e.g., half) portion of auxiliary data corresponding to one UDB stored in the respective row of the second portion 342-2.

Given that each row of the second portion 342-2 is configured to store thirty-two UDBs with its half (e.g., 4 bytes) of auxiliary data for each UDB stored in (the DMI portion of) the same row, in one example, another half (e.g., 4 bytes) of the auxiliary data for each UDB can be stored in a respective DMI portion of (e.g., each row corresponding to) the column selections “60” and “61” shown in FIG. 3A. More particularly, as an example, DMI portions of thirty-two rows (rows “0”, …, “31”) can be respectively configured to store (e.g., a half) auxiliary data for thirty-two UDBs of one row (row “262,143”) of the second portion 342-2. In another example, another half (e.g., 4 bytes) of the auxiliary data for each UDB can be stored in a respective DQ portion of (e.g., each row corresponding to) the column selection “63” shown in FIG. 3A. More particularly, as an example, DQ portions of sixteen rows (rows “0”, …, “15”) can be respectively configured to store (e.g., a half) auxiliary data for thirty-two UDBs of one row of the second portion 342-2.

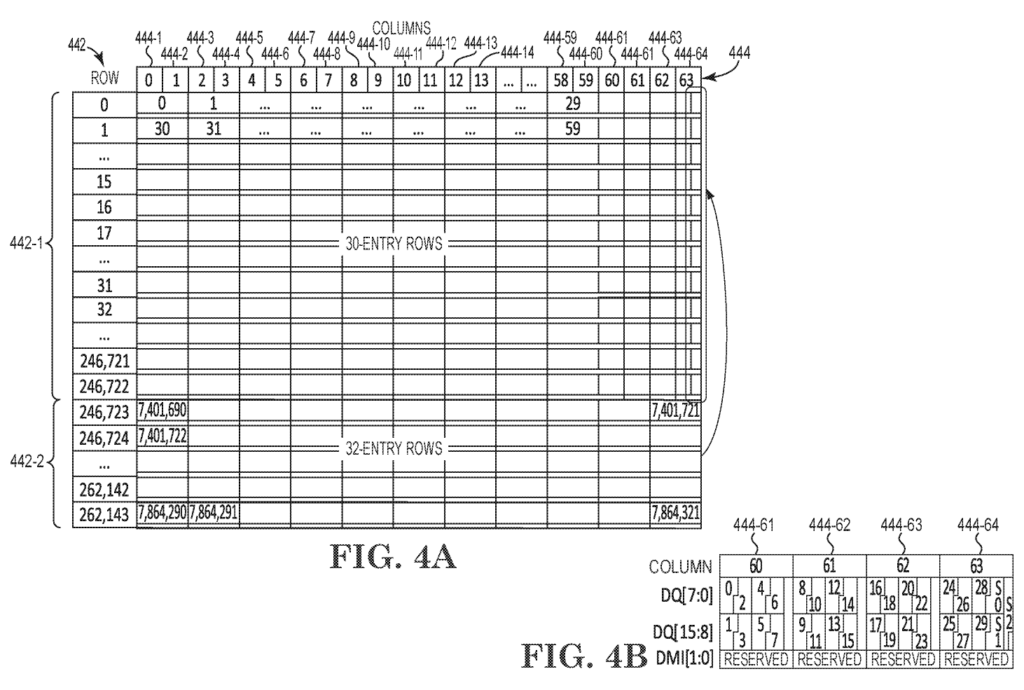

FIG. 4A schematically illustrates another example of data placement on memory dice in accordance with a number of embodiments of the present disclosure. FIG. 4A is generally analogous to FIG. 3A. For example, each row illustrated in FIG. 4A can be a “virtual” row formed from memory dice (e.g., 227-1-1, …, 227-1-X or 227-N-1, …, 227-N-X) in the similar manner as illustrated and described in connection with FIG. 3A. Further, for example, each column selection is distributed over different memory dice, such as two memory dice (e.g., two memory dice 227). More particularly, given that each memory die includes 8 DQ pins and 2 DMI pins, the data transfer from a single column selection over the 32-bit burst length via DQ pins can be 64 bytes (e.g., 32 bytes from each memory die), while the data transfer over the 32-bit burst length via DMI pins can be 4 bytes (e.g., 2 bytes from each memory die). Therefore, data transfer corresponding to the 32-bit burst length can include data transfer of 64 bytes and 4 bytes respectively via DQ pins and DMI pins over the 32-bit burst length.

Similar to the data placement shown in FIG. 3A, each row of a first portion 442-1 can be configured to store both UDBs (e.g., thirty UDBs over column selections “0”, …, “59”) and auxiliary data (over column selections “60”, …, “63”), while each row of a second portion 442-2 can be configured to store UDBs (e.g., thirty-two UDBs over column selections “0”, …, “63”). As described herein, the auxiliary data can include error detection information (e.g., CRC data) generated at the FCRC encoder 211-1 and/or 213-1 of FIG. 2A, error correction information (e.g., alternatively referred to as ECC data) generated at the ECC encoders 216-1, and/or authentication data (e.g., MAC data) generated at the authenticity/integrity check encoder 218-1 that are associated with the UDBs as well as metadata and/or TEE data.

Turning to FIG. 4B, the DQ portion (“DQ[7:0]” and “DQ[15:8]”) of each column selection is configured to store auxiliary data corresponding to UDBs (configured to be) stored in the row “0”. As illustrated in FIG. 4B, the DQ portions (“DQ[7:0]” and “DQ[15:8]”) of each column selection are configured to store auxiliary data corresponding to UDBs stored in row “0”. For example, DQ portions of column selections “60”, …, “63” can be configured to store (e.g., segments of) auxiliary data “0”, …, “29” respectively for those thirty UDBs “0”, …, “29” stored in the row “0” (as illustrated in FIG. 4A). More particularly, a portion of the row “0” corresponding to the column selection “60” can be configured to store auxiliary data “0”, …, “7” respectively for UDBs “0”, …, “7” stored in the row “0”; a portion of the row “0” corresponding to the column selection “61” can be configured to store auxiliary data “8”, …, “15” respectively for UDBs “8”, …, “15” stored in the row “0”; a portion of the row “0” corresponding to the column selection “62” can be configured to store auxiliary data “16”, …, “23” respectively for UDBs “16”, …, “23” stored in the row “0”; and a portion of the row “0” corresponding to the column selection “63” can be configured to store auxiliary data “24”, …, “29” respectively for UDBs “24”, …, “29” stored in the row “0”.

FIG. 4B is presented as a representation for each row of the first portion 442-1 of the memory dice 227, without necessarily limiting the illustration to row “0.” For example, each row of the first portion 442-1 can store auxiliary data in the portions of the row corresponding to column selections “60” through “63,” respectively, for UDBs stored in the same row, in a manner similar to that shown for row “0” in FIG. 4B.

In contrast to the example described in connection with FIGS. 3A and 3B, where each segment of auxiliary data stored in column selections “60” through “63” has a size of 4 bytes, each segment of auxiliary data can instead have a size of 28 bits. Therefore, a respective portion of each column selection (e.g., a row) can have space (e.g., 4 bytes) spared by using a reduced size for each segment (“0”, …., “29” illustrated in FIG. 4B) of auxiliary data. Given this, a portion of the row in one column selection can be configured to store auxiliary data for those UDBs stored in rows of the second portion 442-2. More particularly, as illustrated in FIG. 4B, a portion of the row “0” corresponding to the column selection “63” can be respectively configured to store segments of auxiliary data “S0”, “S1”, and “S2” (respectively corresponding to three UDBs stored in one or more rows of the second portion 442-2) each having a size of 28 bits. In the similar manner, each of the first portion 442-1 can be configured to store segments of auxiliary data (in respective portions corresponding to the column selection “63”) for those UDBs stored in rows of the second portion 442-2.

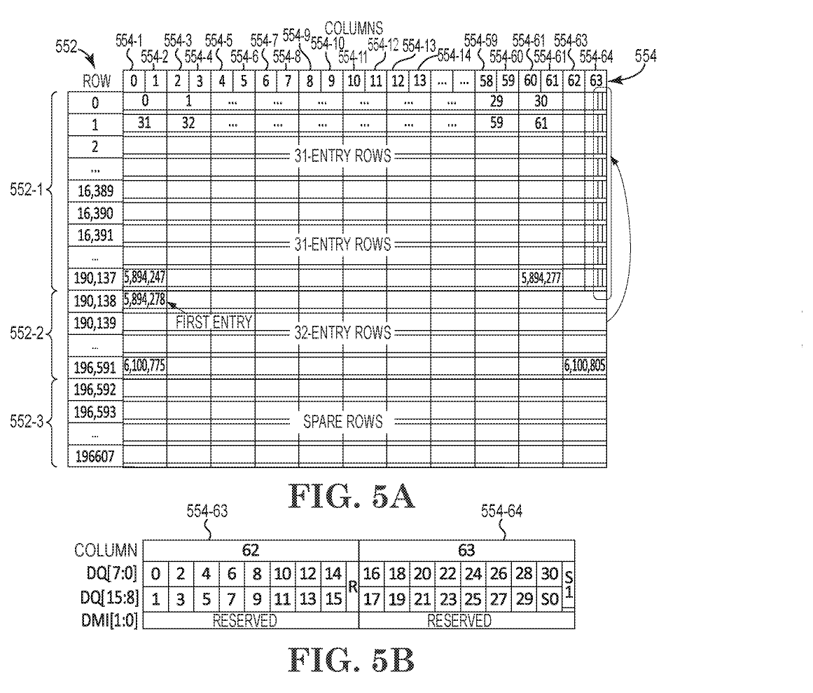

FIG. 5A schematically illustrates another example of data placement on memory dice in accordance with a number of embodiments of the present disclosure. FIG. 5A is generally analogous to FIG. 3A. For example, each row illustrated in FIG. 5A can be a “virtual” row formed from memory dice (e.g., 227-1-1, …, 227-1-X or 227-N-1, …, 227-N-X) in the similar manner as illustrated and described in connection with FIG. 3A. Further, for example, each column selection is distributed over different memory dice, such as two memory dice (e.g., two memory dice 227). More particularly, given that each memory die includes 8 DQ pins and 2 DMI pins, the data transfer from a single column selection over the 32-bit burst length via DQ pins can be 64 bytes (e.g., 32 bytes from each memory die), while the data transfer over the 32-bit burst length via DMI pins can be 4 bytes (e.g., 2 bytes from each memory die). Therefore, data transfer corresponding to the 32-bit burst length can include data transfer of 64 bytes and 4 bytes respectively via DQ pins and DMI pins over the 32-bit burst length.

Data placement shown in FIG. 5A illustrates three different types of rows, such as rows (e.g., of memory cells) of a first portion 552-1, rows of a second portion 552-2, and rows of a third portion 552-3. More particularly, each row of the first portion 552-1 is configured to store both UDBs (e.g., thirty one UDBs over those portions of the row corresponding to column selections “0”. …, “61”) and auxiliary data (over column selections “62”, …, “63”); each row of the second portion 552-2 can be configured to store UDBs (e.g., thirty-two UDBs over column selections “0”, …, “63”); and rows of the third portion 552-3 are configured as “spare” rows. As non-limiting example illustrated in FIG. 5B, the first portion 552-1 of the memory dice 227 can include “190,138” rows (rows “0”, …, “190,137”); the second portion 552-2 of the memory dice 227 can include “6,454” rows (rows “190,138”, …, “196,591”); and the third portion 552-3 of the memory dice 227 can include “16” rows (rows “196,592”, …, “196,607”). As described herein, the auxiliary data can include error detection information (e.g., CRC data) generated at the FCRC encoder 211-1 and/or 213-1 of FIG. 2A, error correction information (e.g., alternatively referred to as ECC data) generated at the ECC encoders 216-1, and/or authentication data (e.g., MAC data) generated at the authenticity/integrity check encoder 218-1 that are associated with the UDBs as well as metadata and/or TEE data.

As used herein, the term “spare rows” refers to additional rows of memory cells included beyond the standard number required for the memory device’s specified capacity. These spare rows can be used to replace defective or faulty rows, either identified during manufacturing or that develop over time, ensuring the memory device can maintain its full capacity and performance. For example, the spare rows of the portion 552-3 can be used to replace any rows of the portions 552-1, 552-2 of the memory dice 227. By providing redundancy, these spare rows enhance the reliability and longevity of the memory system, and they also contribute to improved manufacturing yields by allowing defective rows to be substituted rather than discarding the entire die.

Turning to FIG. 5B, the DQ portion (“DQ[7:0]” and “DQ[15:8]”) of each column selection is configured to store auxiliary data corresponding to UDBs (configured to be) stored in the row “0”. As illustrated in FIG. 5B, the DQ portions (“DQ[7:0]” and “DQ[15:8]”) of each column selection are configured to store auxiliary data corresponding to UDBs stored in row “0”. For example, DQ portions of column selections “62” and “63” can be configured to store (e.g., segments of) auxiliary data “0”, …, “30” respectively for those thirty UDBs “0”, …, “30” stored in the row “0” (as illustrated in FIG. 4A). More particularly, a portion of the row “0” corresponding to the column selection “62” can be configured to store auxiliary data “0”, …, “15” respectively for UDBs “0”, …, “15” stored in the row “0” and a portion of the row “0” corresponding to the column selection “63” can be configured to store auxiliary data “16”, …, “30” respectively for UDBs “16”, …, “30” stored in the row “0”.

FIG. 5B is presented as a representation for each row of the first portion 442-1 of the memory dice 227, without necessarily limiting the illustration to row “0.” For example, each row of the first portion 552-1 can store auxiliary data in the portions of the row corresponding to column selections “62” and “63,” respectively, for UDBs stored in the same row, in a manner similar to that shown for row “0” in FIG. 5B.

In contrast to the example described in connection with FIGS. 3A and 3B (where each segment of auxiliary data stored in the column selections “60, …, “63” having a size of 4 bytes) or FIGS. 4A and 4B (where each segment of auxiliary data stored in the column selections “60, …, “63” having a size of 28 bits), each segment of auxiliary data can have a size of 15 bits. Therefore, a respective portion of (e.g., a row) on each column selection can have a space (e.g., 2 bytes) spared by having a reduced size for each auxiliary data. Given this, a portion of the row on one column selection can be configured to store auxiliary data of those UDBs stored in rows of the second portions 552-2.

In contrast to the example described in connection with FIGS. 3A and 3B (where each segment of auxiliary data stored in column selections “60” through “63” has a size of 4 bytes) or the example described in connection with FIGS. 4A and 4B (where each segment of auxiliary data stored in column selections “60” through “63” has a size of 28 bits), each segment (“0”, …., “30” illustrated in FIG. 5B) of auxiliary data can instead have a size of 15 bits. Therefore, a respective portion of each column selection (e.g., a row) can have space spared by using a reduced size for each segment of auxiliary data.

Given this, a portion of the row in each column selection can be configured to store auxiliary data for those UDBs stored in rows of the second portion 552-2. More particularly, as illustrated in FIG. 5B, a portion of the row “0” corresponding to the column selection “63” can be respectively configured to store segments of auxiliary data “S0” and “S1” (respectively corresponding to two UDBs stored in one or more rows of the second portion 552-2) each having a size of 15 bits. In the similar manner, each row of the first portion 552-1 can be configured to store segments of auxiliary data (in respective portions corresponding to the column selection “63”) for those UDBs stored in rows of the second portion 552-2.

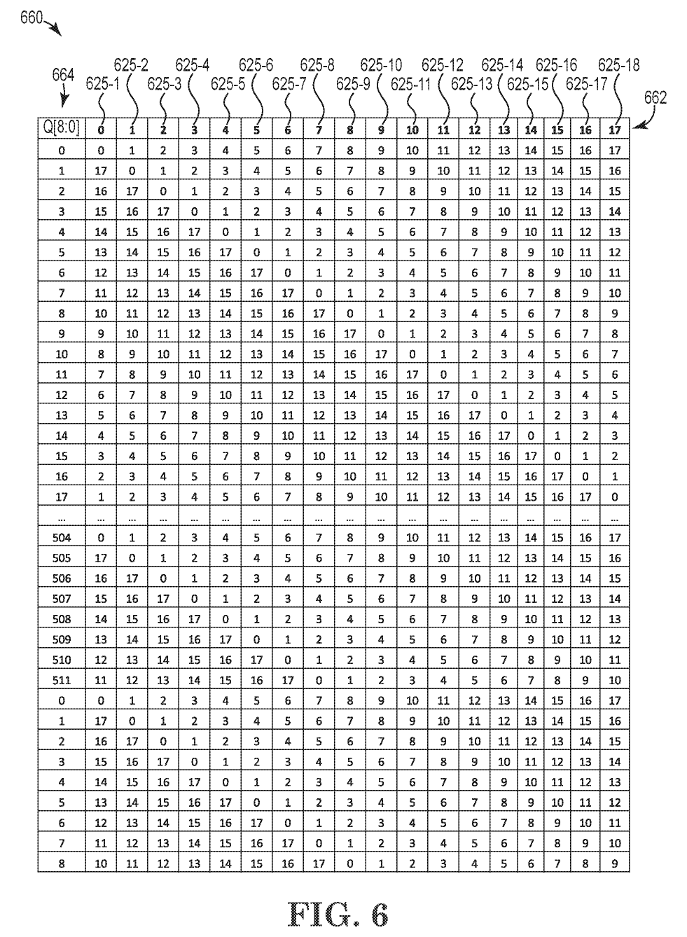

FIG. 6 illustrates an example of how RAID parity data can be spread among “physical” channels (e.g., channels 125, 225 illustrated in FIGS. 1, 2A, 2B) of the memory system (e.g., the memory system 101 illustrated in FIG. 1) in accordance with a number of embodiments of the present disclosure. Entries of a row 662 of the table 660 respectively correspond to eighteen “physical” channels 625-1, …, 625-18, which can be analogous to the channels 125, 225 respectively illustrated in FIGS. 1, 2A, and 2B. Further, entries on a column 664 of a table 660 respectively correspond to five hundred and twenty RAID stripes “0”, …, “511” and “0” ... “8” that are respectively indicated by nine (least significant) bits “Q[8:0]” shown in FIG. 6 (with “Q” of “Q[8:0]” corresponding to a RAID stripe identifier). For example, the table 660 illustrates first five hundred and twelve RAID stripes “0”, …, “511” from the top of the table and subsequent nine RAID stripes “0”, …, “8” located in a bottom portion of the table 660. RAID stripe identifiers “0”, …, “8” appear repetitively (e.g., twice) due to the use of 9 bits for indicating the identifiers and to reduce the design complexity. Although FIG. 6 illustrates a particular quantity of RAID stripes and channels, embodiments are not limited to those particular quantities of RAID stripes and/or channels the embodiments of the present disclosure can be implemented to.

As illustrated herein, each RAID stripe includes eighteen subsets of data (alternatively referred to as RAID “strips”), such as subsets “0”, …, “17”, of which a subset “17” of each RAID stripe corresponds to a RAID parity. For example, those subsets “17” can represent subsets corresponding to the logical channel “17”. As used herein, the RAID stripe refers to a number of strips that are collectively used for a RAID operation. For example, a RAID stripe “0” can include RAID strips “0”, …, “16”, which can be used to generate a RAID parity “17”. Therefore, performing a RAID operation, for example, to recover RAID strip “0” of the RAID stripe “0” can include comparing (e.g., XORing) each subset (e.g., subsets “1”, …, “17”) of the RAID stripe “0”.

These numerical values (e.g., “0”, …, “17”) of subsets of each RAID stripe also indicate a logical channel via which each subset can be accessed. For example, a subset “0” of the RAID stripe “0” (stored in a memory device coupled via the channel “0”) can be accessed via the logical channel “0”, while a subset “0” of the RAID stripe “1” (stored in a memory device coupled via the channel “1”) can be also accessed via the logical channel “0”. Therefore, as illustrated in FIG. 6, those subsets of RAID stripes belonging to the same “logical” channel can be (e.g., substantially) evenly distributed over different “physical” channels 625. For example, subsets “0” of the first eighteen RAID stripes (e.g., RAID stripes “0” to “17”) can be evenly distributed over different “physical” channels 625 such that they can be accessed respectively via different “physical” channels 625.

For example, for the first eighteen RAID stripes (e.g., RAID stripes “0” to “17”), RAID parity can be distributed across eighteen “physical” channels 625 in such a way that none of the “physical” channels 625 is configured to store the RAID parity for more than one RAID stripe. More particularly, a RAID parity “17” of the RAID stripe “0” can be stored in the channel 625-18 (e.g., the channel “17” shown in FIG. 6); a RAID parity “17” of the RAID stripe “1” can be stored in the channel 625-1 (e.g., the channel “0” shown in FIG. 6); a RAID parity “17” of the RAID stripe “2” can be stored in the channel 625-2 (e.g., the channel “1” shown in FIG. 6), …, ; and a RAID parity “17” of the RAID stripe “17” can be stored in the channel 625-17 (e.g., the channel “16” shown in FIG. 6). As illustrated in FIG. 6, this pattern shown over the first eighteen RAID stripes (e.g., RAID stripes “0” to “17”) can be repeated for subsequent RAID stripes in units of eighteen RAID stripes. Therefore, each unit of eighteen RAID stripes can be configured to store RAID parity for no more than one RAID stripe. In some embodiments, this pattern may be discontinued and reset once it reaches the RAID stripe “511”. For example, Although a RAID parity “17” of the RAID stripe “511” is stored in the channel 625-8 (e.g., the channel “7” shown in FIG. 6), a RAID parity “17” of the RAID stripe “0” (e.g., located below the RAID stripe “511” as shown in the table 660) is stored in the channel 625-1 rather than in the channel 625-9, allowing the pattern to start again.

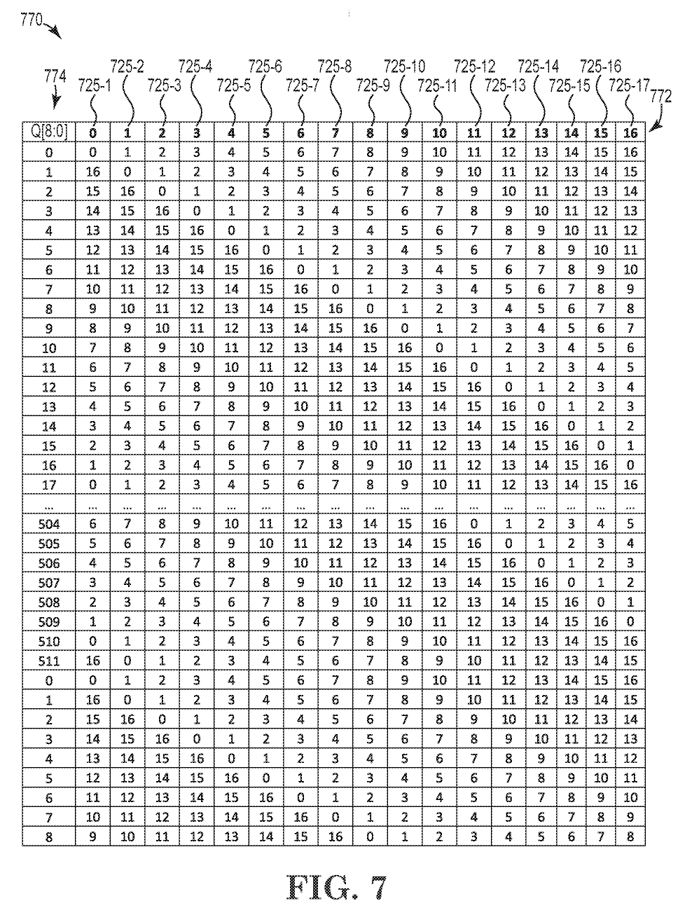

FIG. 7 illustrates another example of how RAID parity data can be spread among “physical” channels (e.g., channels 125, 225 illustrated in FIGS. 1, 2A, 2B) of the memory system (e.g., the memory system 101 illustrated in FIG. 1) in accordance with a number of embodiments of the present disclosure. Entries of a row 772 of the table 770 respectively correspond to seventeen “physical” channels 725-1, …, 725-17, which can be analogous to the channels 125, 225 respectively illustrated in FIGS. 1, 2A, and 2B. Further, entries on a column 774 of a table 770 respectively correspond to five hundred and twenty RAID stripes “0”, …, “511”and “0” ... “8” that are respectively indicated by nine (least significant) bits “Q[8:0]” shown in FIG. 7. For example, the table 770 illustrates first five hundred and eleven RAID stripes “0”, …, “511” from the top of the table and subsequent nine RAID stripes “0”, …, “8” located in a bottom portion of the table 770. RAID stripe identifiers “0”, …, “8” appear repetitively (e.g., twice) due to the use of 9 bits for indicating the identifiers and to reduce the design complexity. Although FIG. 7 illustrates a particular quantity of RAID stripes and channels, embodiments are not limited to those particular quantities of RAID stripes and/or channels the embodiments of the present disclosure can be implemented to.

FIG. 7 is generally analogous to FIG. 6 except that there are seventeen subsets for each RAID stripe “0”, …, “511” that are distributed over seventeen different channels 725-1, …, 725-17 in a manner that none of the channels 725 (within each unit of seventeen RAID stripes) is configured to store the RAID parity for more than one RAID stripe. For example, for the first seventeen RAID stripes (e.g., RAID stripes “0” to “16”), RAID parity can be distributed across eighteen “physical” channels 725 in such a way that none of the “physical” channels 725 is configured to store the RAID parity for more than one RAID stripe. More particularly, a RAID parity “16” of the RAID stripe “0” can be stored in the channel 725-17 (e.g., the channel “16” shown in FIG. 7); a RAID parity “16” of the RAID stripe “1” can be stored in the channel 725-1 (e.g., the channel “0” shown in FIG. 7); a RAID parity “16” of the RAID stripe “2” can be stored in the channel 725-2 (e.g., the channel “1” shown in FIG. 7), …, ; and a RAID parity “16” of the RAID stripe “16” can be stored in the channel 725-15(e.g., the channel “15” shown in FIG. 7). As illustrated in FIG. 7, this pattern shown over the first eighteen RAID stripes (e.g., RAID stripes “0” to “16”) can be repeated for subsequent RAID stripes in units of seventeen RAID stripes. Therefore, each unit of seventeen RAID stripes can be configured to store RAID parity for no more than one RAID stripe.

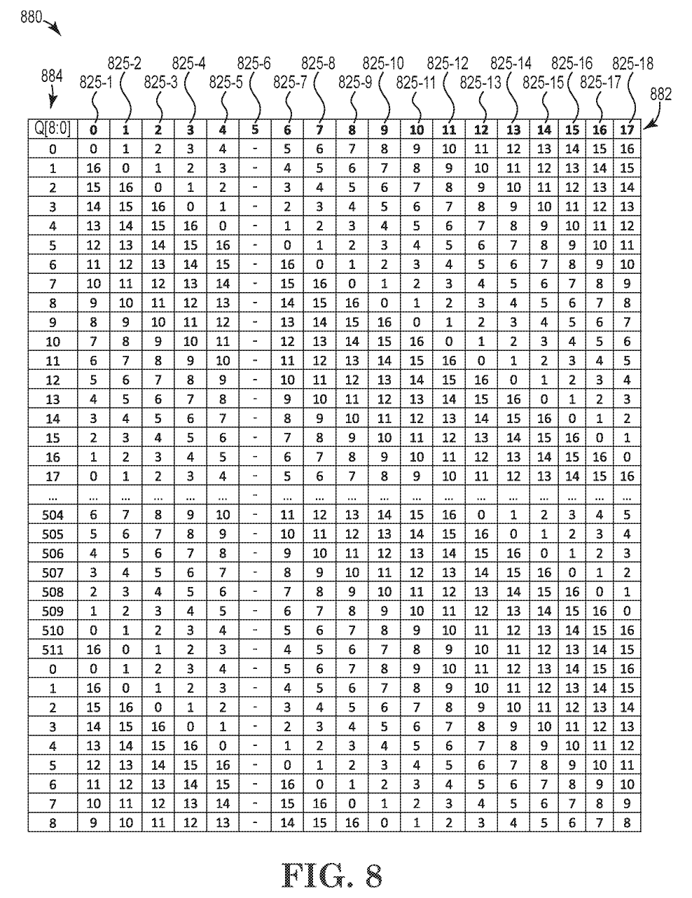

FIG. 8 illustrates another example of how RAID parity data can be spread among channels of the memory system in accordance with a number of embodiments of the present disclosure. Entries of a row 882 of the table 880 respectively correspond to eighteen “physical” channels 825-1, …, 825-18, which can be analogous to the channels 125, 225 respectively illustrated in FIGS. 1, 2A, and 2B. Further, entries on a column 884 of a table 880 respectively correspond to a number of RAID stripes “0”, …, “511”. Although FIG. 8 illustrates a particular quantity of RAID stripes and channels, embodiments are not limited to those particular quantities of RAID stripes and/or channels the embodiments of the present disclosure can be implemented to.

FIG. 8 is generally analogous to FIG. 7 except that FIG. 8 illustrates a scenario where one or more memory devices corresponding to the physical channel “5” is no longer in use such that a different channel (e.g., channel “6”) is reconfigured to replace the channel “5”. As such, instead of the “physical” channel “5”, the “physical” channel “17” can be reconfigured to be part of those channels 125, 225 over which subsets of RAID stripes can be distributed. For example, taking an example of a RAID stripe “0”, memory devices coupled to “physical” channels “0”, …, “4” can be sequentially configured to store subsets “0”, …, “4”. Since the “physical” channel “5” is not in use, the “physical” channel “6”, …, “17” can be sequentially configured to store subsets “5”, …, “16”. In some embodiments, the “physical” channel that is not in use may not be used again as it may no longer be reliable (resulting in a reduced device capacity).

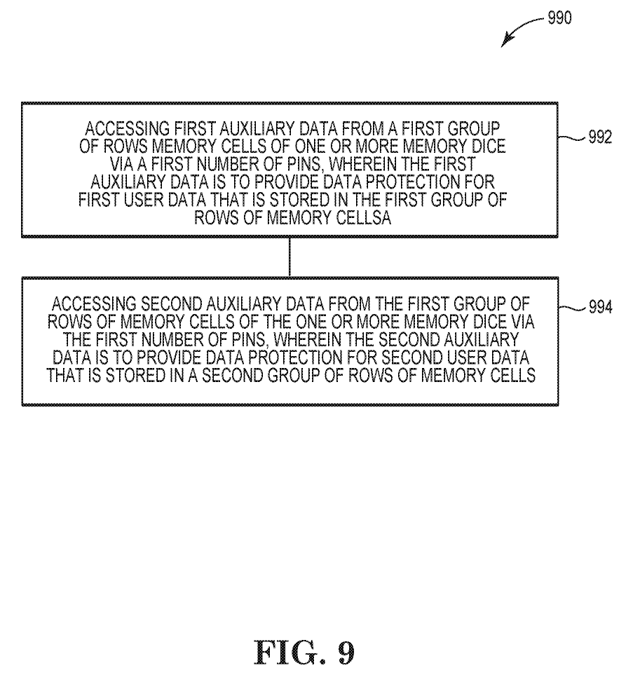

FIG. 9 is a flow diagram corresponding to a method 990 for distributing and providing data protection for auxiliary data in accordance with a number of embodiments of the present disclosure. The method 990 can be performed by processing logic (e.g., the controller 100, 200 illustrated in FIGS. 1-2, respectively) or one or more memory dice (e.g., the memory dice 127, 227 illustrated in FIGS. 1-2, respectively) that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 992, the method 990 includes accessing first auxiliary data (e.g., a respective one of segments of auxiliary data “0”, …, “29” illustrated in FIGS. 3B, 4B, 5B, respectively) from a first group of rows memory cells (e.g., rows of memory dice 227 corresponding to virtual rows “0”, …, “246,722” of the first portion 342-1, 442-1 illustrated in FIGS. 3B, 4B, respectively, and/or rows “0”, …, “190,137” of the first portion 552-1 illustrated in FIG. 5B) of one or more memory dice (e.g., the memory dice 227 illustrated in FIGS. 2A, 2B, respectively and corresponding to the same channel 125, 225 illustrated in FIGS. 1, 2A, 2B, respectively) via a first number of pins. The first auxiliary data is to provide data protection for first user data (e.g., UDBs stored in rows of the first portion 342-1, 442-1, 552-1 illustrated in FIGS. 3B, 4B, 5B, respectively) that is stored in the first group of rows of memory cells. At 994, the method 990 includes accessing second auxiliary data (e.g., a respective one of segments of auxiliary data “S0”, “S1”, “S2” illustrated in FIGS. 3B, 4B, 5B, respectively) from the first group of rows of memory cells of the one or more memory dice 227 via the first number of pins (DQ pins). The second auxiliary data is to provide data protection for second user data (e.g., UDBs stored in rows of the second portion 342-2, 442-2, 552-2 illustrated in FIGS. 3B, 4B, 5B, respectively) that is stored in a second group of rows of memory cells (e.g., rows of memory dice 227 corresponding to virtual rows “246,723”, …, “262,143” of the first portion 342-1, 442-1 illustrated in FIGS. 3B, 4B, respectively, and/or rows “190,138”, …, “196,591” of the first portion 552-1 illustrated in FIG. 5B).

In some embodiments, the method 990 further includes accessing third auxiliary data (e.g., a segment of auxiliary data “S2” illustrated in FIGS. 3B) from the first group of rows of memory cells of the one or more memory dice 227 via a second number of pins (e.g., DMI pins). The third auxiliary data is to provide data protection for third user data (e.g., UDBs stored in rows of the second portion 342-2, 442-2, 552-2 illustrated in FIGS. 3B, 4B, 5B, respectively) that is stored in a third group of rows of memory cells.

In some embodiments, the method 990 can further includes accessing the first user data from the first group of rows memory cells of the one or more memory dice 227 via the first number of pins, wherein the first auxiliary data and the second auxiliary data are accessed as part of the access to the first user data. Alternatively, the method 990 can further includes accessing the second user data from the second group of rows memory cells of the one or more memory dice 227 via the first number of pins, wherein the first auxiliary data and the second auxiliary data are accessed as part of the access to the second user data.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
accessing first auxiliary data from a first group of rows memory cells of one or more memory dice via a first number of pins, wherein the first auxiliary data is to provide data protection for first user data that is stored in the first group of rows of memory cells; and
accessing second auxiliary data from the first group of rows of memory cells of the one or more memory dice via the first number of pins, wherein the second auxiliary data is to provide data protection for second user data that is stored in a second group of rows of memory cells.

2. The method of claim 1, further comprising accessing third auxiliary data from the first group of rows of memory cells of the one or more memory dice via a second number of pins, wherein the third auxiliary data is to provide data protection for third user data that is stored in a third group of rows of memory cells, and wherein:
the first number of pins correspond to one or more data input/output (DQ) pins; and
the second number of pins correspond to one or more data mask inversion (DMI) pins.

3. The method of claim 1, further comprising:
accessing the first user data from the first group of rows memory cells of the one or more memory dice via the first number of pins, wherein the first auxiliary data and the second auxiliary data are accessed as part of the access to the first user data.

4. The method of claim 1, further comprising:
accessing the second user data from the second group of rows memory cells of the one or more memory dice via the first number of pins, wherein the first auxiliary data and the second auxiliary data are accessed as part of the access to the second user data.

5. An apparatus, comprising:
a first number of rows of memory cells of a memory array, each row of memory cells of the first number of rows further comprises:
a respective first portion configured to store:
first user data;
a first portion of first auxiliary data, the first auxiliary data to provide data protection for the first user data; and
second auxiliary data corresponding to second user data, the second auxiliary data to provide data protection for the second user data; and
a respective second portion configured to store a second portion of the first auxiliary data.

6. The apparatus of claim 5, wherein the respective second portion is further configured to store another portion of the second auxiliary data corresponding to the second user data.

7. The apparatus of claim 5, wherein:
the respective first portion of each row of memory cells of the first number of rows is configured to exchange respective data via a number of data input/output (DQ) pins; and
the respective second portion of each row of memory cells of the first number of rows is configured to exchange respective data via a number of data mask inversion (DMI) pins.

8. The apparatus of claim 5, wherein the first number of rows of memory cells are partitioned into a plurality of column selections, the plurality of column selections comprising:
a first number of column selections of the plurality configured to store the first user data; and
a second number of column selections of the plurality is configured to store the first auxiliary data and the second auxiliary data.

9. The apparatus of claim 8, wherein the second number of column selections further comprising:
one or more first column selections configured to store:
a portion of the first auxiliary data; and
a portion of the second auxiliary data; and
one or more second column selections configured to store:
another portion of the first auxiliary data; and
another portion of the second auxiliary data.

10. The apparatus of claim 9, wherein at least a portion of the one or more second column selections is configured to exchange data via one or more data mask inversion (DMI) pins are reserved.

11. The apparatus of claim 9, wherein:
the one or more first column selections of the second number are configured to:
exchange the portion of the first auxiliary data via a number of data input/output (DQ) pins; and
exchange the portion of the second auxiliary data via the number of DQ pins; and
the one or more second column selections of the second number are configured to:
exchange the another portion of the first auxiliary data via a number of data mask inversion (DMI) pins; and
exchange the another portion of the second auxiliary data via the number of DMI pins.

12. The apparatus of claim 8, wherein the second number of column selections further comprising:
one or more first column selections configured to store a portion of the first auxiliary data; and
one or more second column selections configured to store:
another portion of the first auxiliary data; and
the second auxiliary data.

13. The apparatus of claim 12, wherein at least a portion of the one or more first column selections that is configured to exchange data via one or more data mask inversion (DMI) pins are reserved.

14. The apparatus of claim 12, wherein at least a portion of the one or more first column selections that is configured to exchange data via one or more data input/output (DQ) pins are reserved.

15. The apparatus of claim 12, wherein at least a portion of the one or more second column selections that is configured to exchange data via one or more data mask inversion (DMI) pins are reserved.

16. The apparatus of claim 12, wherein:
the one or more first column selections of the second number are configured to:
exchange the portion of the first auxiliary data via a number of data input/output (DQ) pins; and
the one or more second column selections of the second number are configured to:
exchange the another portion of the first auxiliary data via the number of DQ pins; and
exchange the another portion of the second auxiliary data via the number of DQ pins.

17. An apparatus, comprising:
one or more memory dice, the one or more memory dice configured to, during one or more predefined burst lengths:
exchange a signal indicative of first user data via a first data link, wherein the first user data is stored in memory cells coupled to a first group of rows of the one or more memory dice;
exchange a signal indicative of first auxiliary data via the first data link to provide data protection for first user data, wherein the first auxiliary data is stored in memory cells coupled to the first group of rows of the one or more memory dice; and
exchange a signal indicative of second auxiliary data via the first data link, wherein the second auxiliary data is to provide data protection for second auxiliary data stored in memory cells coupled to a second group of rows of the one or more memory dice.

18. The apparatus of claim 17, wherein the one or more memory dice is further configured to, during the one or more predefined burst lengths:
exchange a signal indicative of third auxiliary data via a second data link, wherein the third auxiliary data is to provide data protection for third auxiliary data stored in memory cells coupled to a third group of rows of the one or more memory dice.

19. The apparatus of claim 18, wherein:
the first data link comprises one or more data input/output (DQ) pins; and
the second data link comprises one or more data mask inversion (DMI) pins.

20. The apparatus of claim 18, wherein the first auxiliary data, the second auxiliary data, the third auxiliary data, or any combination thereof, comprises parity data, cyclic redundancy check (CRC) information, or any combination thereof.
